(19) United States
(12) Patent Application Publication
(10) Pub. No.: US 2013/0301250 A1
(43) Pub. Date: Nov. 14, 2013

(54) COOLING DEVICE OF LED LIGHTING LIFTING SYSTEM AND LED LIGHTING LIFTING SYSTEM HAVING THE SAME

(71) Applicant: Jeong-Hun Shin, Suncheon-si (KR)

(72) Inventor: Jeong-Hun Shin, Suncheon-si (KR)

(21) Appl. No.: 13/981,040

(22) PCT Filed: Jan. 20, 2012
(86) PCT No.: PCT/KR2012/000562

§ 371 Date: Jul. 22, 2013

(30) Foreign Application Priority Data
Jan. 21, 2011 (KR) 10-2011-0006178

(51) Int. Cl. F21V 29/02

(52) U.S. Cl. CPC F21V 29/025
USPC 362/147

(57) ABSTRACT

An LED lighting lifting system includes a lifting device installed at the ceiling of a building to move a lifting body upwards or downwards by using a wire; and an LED lighting connected to a lower end of the lifting body and moving downwards to the ground or upwards to the ceiling together with the lifting body. A cooling device is installed between the lifting body and the LED lighting to prevent the LED lighting from being broken due to a high temperature generated when a current over a rated current flows at the LED lighting.

### CROSS-REFERENCE TO RELATED APPLICATIONS

The present application claims priority to Korean Patent Application No. 10-2011-0006178 filed in the Republic of Korea on Jan. 21, 2011, and PCT Application No. PCT/KR2012/000562 filed on Jan. 20, 2012, the disclosures of which are incorporated herein by reference.

### TECHNICAL FIELD

The present invention relates to a cooling device of an LED lighting lifting system, and more particularly, to a cooling device of an LED lighting lifting system, which is provided at an LED lighting, installed at the ceiling of a building to move upwards or downwards by a lifting device, to cool the heat generated from the LED lighting so that the LED lighting may be efficiently used and surrounding products may have improved durability.

### BACKGROUND

Generally, a highly-mounted lighting is installed at a hotel lobby, a factory, a church, a theater, a welling hall, a banquet hall, an oil station, a restaurant, a coffee shop, a department store or the like, which have a high ceiling. The highly-mounted lighting has no serious problem at its initial use, but, lightings should be periodically recycled due to the limited life span, exchanged due to the failure or periodically cleaned to extend their life span.

In order to exchange or clean the highly-mounted lighting installed at a high ceiling, high place equipment such as a tower wagon, a tower crane or a ladder truck such be separately used.

Such a high place work is much more inconvenient and demands high-level workmanship in comparison to the work on the ground. In particular, during a high place work, workers are always exposed to accidents such as an electric shock or falling. In addition, the use of high place equipment increases costs, which lays a burden in an economic aspect.

Therefore, in view of the above drawbacks, a lighting lifting device for allowing light bulbs of a highly-mounted lighting to be safely and conveniently exchanged or cleaned on the ground has been recently developed.

In brief, the lighting lifting device includes a lifting device installed or fixed to the ceiling of a building to move a lifting body upwards or downwards by using a wire, a lighting connected to the lower end of the lifting body to move downwards to the ground or upwards to the ceiling together with the lifting body, and a remote controller wirelessly communicating with the lifting device bidirectionally and allowing a ascending signal or a descending signal to be input to the lifting device at the ground.

If the lighting lifting device configured as above is used, the lighting may be safely moved to the ground and then exchanged or cleaned.

However, such a general lighting has low energy efficiency. In this regard, a lighting device using a light emitting diode (LED) has higher energy efficiency in comparison to other lighting devices such as a fluorescent lamp, a mercury lamp or an incandescent lamp and does not discharge contaminants while ensuring a long life span. Therefore, general lightings are substituted with LED lightings in these days.

In the lighting device using an LED lighting as described above, if a rated current flows at the LED lighting, the lighting device generally maintains about 60° C. However, if a current over the rated current flows, the LED lighting may be easily broken due to a high temperature. When a current flows at the LED lighting, both ends of the LED lighting basically have a constant voltage characteristic, but if the current increases, the voltage also increases very finely. In addition, if the current increases over a predetermined limit, the caloric value rapidly increases, and the LED lighting is broken due to the overheat. Moreover, the high temperature generated when the lighting turns on may seriously deteriorate surrounding products.

### SUMMARY

The present invention is directed to providing a cooling device of an LED lighting lifting system, which is provided at an LED lighting, installed at the ceiling of a building to move upwards or downwards by a lifting device, to cool the heat generated from the LED lighting so that the LED lighting may be efficiently used and surrounding products may have improved durability.

In one aspect of at least one embodiment of the present invention, there is provided a cooling device of a light emitting diode (LED) lighting lifting system including a lifting device installed at the ceiling of a building to move a lifting body upwards or downwards by using a wire; and an LED lighting connected to a lower end of the lifting body and moving downwards to the ground or upwards to the ceiling together with the lifting body, wherein the cooling device is installed between the lifting body and the LED lighting to prevent the LED lighting from being broken due to a high temperature generated when a current over a rated current flows at the LED lighting.

Preferably, the cooling device may include a cooling box having a rectangular box shape and integrally connected to the lifting device so that the LED lighting is installed at a lower end thereof; an inhaling cooling fan formed at one side of the cooling box to inhale an external fresh air; a discharging cooling fan located at a side opposite to the inhaling cooling fan and formed at the other side of the cooling box to forcibly discharge the heat generated from the LED lighting; a plurality of cooling pillars arranged in the cooling box with regular intervals in the vertical direction to absorb the heat generated from the LED lighting; a cooling cap coupled to an upper end of the cooling box so that the cooling box has a perfect rectangular box shape, the lifting body being fixed to an upper end thereof; and a plurality of discharging pillars formed at the same location as the cooling pillars formed in the cooling box and protruding outwards at the upper end of the cooling cap to discharge the heat absorbed by the cooling pillars to the outside, wherein when an ascending signal is input to the lifting device, the lifting body, the LED lighting and the cooling box simultaneously move upwards by the wire, and when the upward movement is completed, power is applied to the lifting device to turn on the LED lighting.

In another aspect of at least one embodiment of the present invention, there is also provided an LED lighting lifting system having the above cooling device.

As described above, according to at least one embodiment of the present invention, a cooling device is integrally provided to an LED lighting which moves upwards or downwards by means of a lifting device.

Therefore, since the heat generated from the LED lighting is cooled by the cooling device, it is possible to prevent the LED lighting from being broken due to overheating, and therefore durability of surrounding products is improved.

In particular, since the LED lighting lifting system according at least one embodiment of the present invention includes a cooling pillar for absorbing heat in a cooling box and discharges the heat absorbed by the cooling pillar to the outside by means of forced convection using a fan, the heat generated from the LED lighting may be efficiently cooled.

### BRIEF DESCRIPTION OF DRAWINGS

FIG. 1 is a perspective view showing a cooling device according to at least one embodiment of the present invention, which is installed between a lifting device and an LED lighting.

FIG. 2 is an exploded perspective view showing the cooling device according to the at least one embodiment of present invention.

### REFERENCE NUMERALS

| | |
|---|---|
| 100: lifting device | 110: wire |
| 120: lifting body | 200: LED lighting |
| 300: cooling device | 310: inhaling cooling fan |
| 310a: discharging cooling fan | 320: cooling box |
| 330: cooling pillar | 340: cooling cap |
| 350: discharging pillar | |

### DETAILED DESCRIPTION

Hereinafter, preferred embodiments of the present invention will be described in detail with reference to the accompanying drawings.

Prior to describing a cooling device of the present invention, the related art will be described. An LED lighting lifting system according to at least one embodiment of the present invention includes a lifting device 100 installed at the ceiling of a building to move a lifting body 120 upwards or downwards by using a wire 110, and an LED lighting 200 connected to a lower end of the lifting body 120 and moving downwards to the ground or upwards to the ceiling together with the lifting body 120. The lifting device 100 wirelessly communicates with a remote controller (not shown) bidirectionally. If an ascending signal or a descending signal is input to the lifting device 100 by using the remote controller, the lifting body 120 and the LED lighting 200 are operated to move upwards or downwards according to the ascending signal or the descending signal of the remote controller. The overall techniques of the lifting device are substantially well known in the art.

First, the lifting device 100 winds or unwinds the wire 110 to move the lifting body 120 and the LED lighting 200 upwards or downwards, and the lifting device 100 makes wireless communication with the remote controller bidirectionally to control the ascending or descending movement. This configuration is well known in the art and not described in detail here.

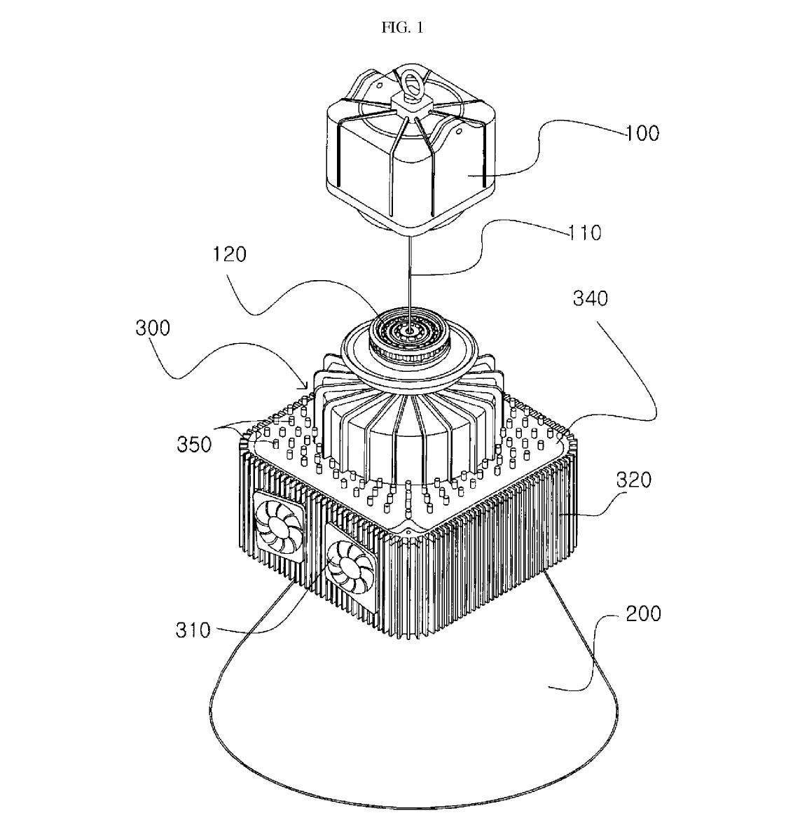

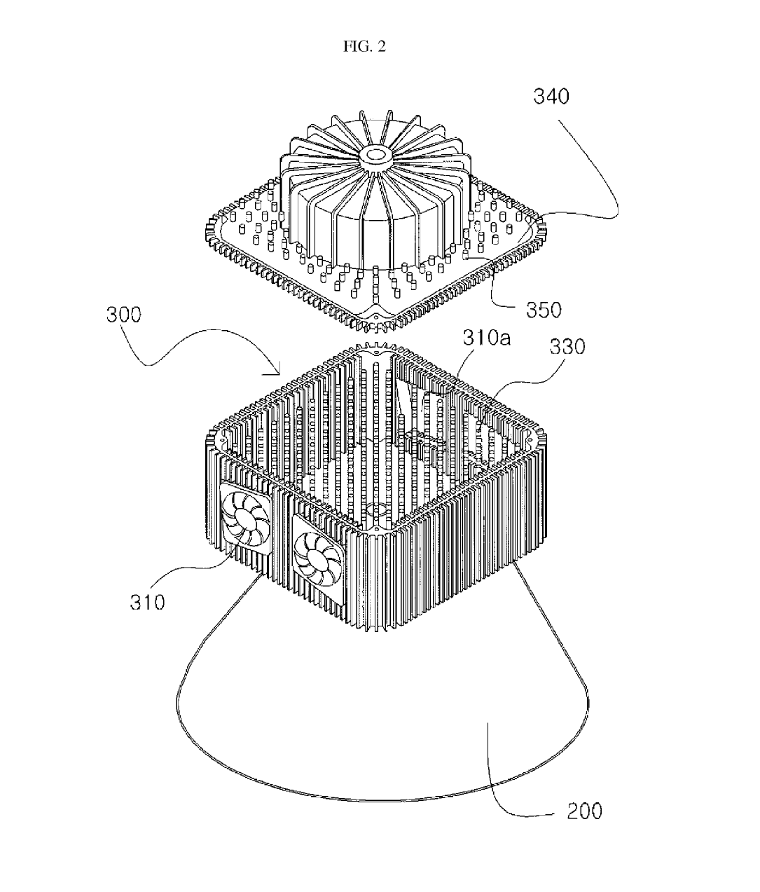

In order to effectively cool the heat generated from the LED lighting 200, the LED lighting lifting system according to at least on embodiment of the present invention basically includes a cooling device 300 between the lifting body 120 and the LED lighting 200 as shown in FIGS. 1 and 2, so that the heat generated from the LED lighting 200 may be cooled by the cooling device 300.

The cooling device 300 includes a cooling box 320 having a rectangular box shape so that the LED lighting 200 is installed at a lower end thereof, an inhaling cooling fan 310 formed at one side of the cooling box 320 to inhale an external fresh air, a discharging cooling fan 310a located at a side opposite to the inhaling cooling fan 310 and formed at the other side of the cooling box 320 to forcibly discharge the heat generated from the LED lighting 200, a plurality of cooling pillars 330 arranged in the cooling box 320 with regular intervals in the vertical direction to absorb the heat generated from the LED lighting 200, a cooling cap 340 coupled to an upper end of the cooling box 320 so that the cooling box 320 has a perfect rectangular box shape, the lifting body 120 being fixed to an upper end thereof, and a plurality of discharging pillars 350 formed at the same location as the cooling pillars 330 formed in the cooling box 320 and protruding outwards at the upper end of the cooling cap 340 to discharge the heat absorbed by the cooling pillars 330 to the outside.

When the inhaling cooling fan 310 and the discharging cooling fan 310a are installed to the cooling box 320, the inhaling cooling fan 310 and the discharging cooling fan 310a may be formed at both sides of the cooling box 320, respectively, so that an external air is inhaled and an inside air is discharged. For example, if the inhaling cooling fan 310 is formed at the front surface, the discharging cooling fan 310a is formed at the rear surface of the cooling box 320 so that the inside air may be forcibly discharged outwards

In particular, since the cooling device 300 of the present invention is used for cooling the LED lighting 200, the cooling device 300 may have a box shape with a sealed space. In this case, the cooling box 320 and the cooling cap 340 are coupled to configure a single cooling device 300, the heat generated from the LED lighting 200 is collected in the cooling device 300, and the collected heat is forcibly circulated by the inhaling cooling fan 310 and the discharging cooling fan 310a. During the forced circulation, the heat generated from the LED lighting 200 is more effectively cooled by the cooling pillar 330 and the discharging pillar 350. In other words, the heat generated from the LED lighting 200 is discharged out by means of forced convection, rather than natural convection.

In order to use the present invention configured as above, the cooling box 320 in which the plurality of cooling pillars 330 are arranged in the vertical direction and the cooling cap 340 having the plurality of discharging pillars 350 at the upper end thereof are prepared. Here, the inhaling cooling fan 310 and the discharging cooling fan 310a are installed at the front surface and the rear surface of the cooling box 320, respectively. After that, the cooling cap 340 is connected to the lifting body 120, and the cooling box 320 is coupled to the LED lighting 200. In this case, the cooling device 300 having a box shape is integrally connected to the lifting device 100.

If an ascending signal is input to the lifting device 100 by using a remote controller, the lifting body 120, the LED lighting 200 and the cooling box 300 of the lifting device 100 simultaneously move upwards by means of the wire 110. If the ascending movement is completed, power is applied to the lifting device 100 to turn on the LED lighting 200.

In the above state, if the LED lighting 200 is used for a long time, the LED lighting 200 is overheated to generate high-temperature heat. At this time, the cooling pillar 330 absorbs the high-temperature heat, and the absorbed heat is discharged to the outside via the cooling pillars 330 through the discharging pillars 350.

In addition, the inhaling cooling fan 310 formed at one side of the cooling box 320 inhales an external cool air to the inside to decrease the overall inside temperature of the cooling box 320. The air mixed with the internal high-temperature heat is discharged out through the discharging cooling fan 310a. This external air inhaling process and the internal hot air discharging process continuously repeat, which allows the high-temperature heat generated from the LED lighting 200 to be easily cooled.

1. A cooling device of a light emitting diode (LED) lighting lifting system including a lifting device installed at the ceiling of a building to move a lifting body upwards or downwards by using a wire; and an LED lighting connected to a lower end of the lifting body and moving downwards to the ground or upwards to the ceiling together with the lifting body,
wherein the cooling device is installed between the lifting body and the LED lighting to prevent the LED lighting from being broken due to a high temperature generated when a current over a rated current flows at the LED lighting.

2. The cooling device of an LED lighting lifting system according to claim 1, wherein the cooling device includes:
a cooling box having a rectangular box shape and integrally connected to the lifting device so that the LED lighting is installed at a lower end thereof;
an inhaling cooling fan formed at one side of the cooling box to inhale an external fresh air;
a discharging cooling fan located at a side opposite to the inhaling cooling fan and formed at the other side of the cooling box to forcibly discharge the heat generated from the LED lighting;
a plurality of cooling pillars arranged in the cooling box with regular intervals in the vertical direction to absorb the heat generated from the LED lighting;
a cooling cap coupled to an upper end of the cooling box so that the cooling box has a perfect rectangular box shape, the lifting body being fixed to an upper end thereof; and
a plurality of discharging pillars formed at the same location as the cooling pillars formed in the cooling box and protruding outwards at the upper end of the cooling cap to discharge the heat absorbed by the cooling pillars to the outside,
wherein when an ascending signal is input to the lifting device, the lifting body, the LED lighting, and the cooling box simultaneously move upwards by the wire, and when the upward movement is completed, power is applied to the lifting device to turn on the LED lighting.

3. An LED lighting lifting system, which includes a lifting device installed at the ceiling of a building to move a lifting body upwards or downwards by using a wire; and an LED lighting connected to a lower end of the lifting body and moving downwards to the ground or upwards to the ceiling together with the lifting body,
wherein a cooling device is installed between the lifting body and the LED lighting to prevent the LED lighting from being broken due to a high temperature generated when a current over a rated current flows at the LED lighting.

4. The LED lighting lifting system according to claim 3, wherein the cooling device includes:
a cooling box having a rectangular box shape and integrally connected to the lifting device so that the LED lighting is installed at a lower end thereof;
an inhaling cooling fan formed at one side of the cooling box to inhale an external fresh air;
a discharging cooling fan located at a side opposite to the inhaling cooling fan and formed at the other side of the cooling box to forcibly discharge the heat generated from the LED lighting;
a plurality of cooling pillars arranged in the cooling box with regular intervals in the vertical direction to absorb the heat generated from the LED lighting;
a cooling cap coupled to an upper end of the cooling box so that the cooling box has a perfect rectangular box shape, the lifting body being fixed to an upper end thereof; and
a plurality of discharging pillars formed at the same location as the cooling pillars formed in the cooling box and protruding outwards at the upper end of the cooling cap to discharge the heat absorbed by the cooling pillars to the outside,
wherein when an ascending signal is input to the lifting device, the lifting body, the LED lighting, and the cooling box simultaneously move upwards by the wire, and when the upward movement is completed, power is applied to the lifting device to turn on the LED lighting.
